(19) United States
(12) Patent Application Publication
(10) Pub. No.: US 2006/0083370 A1
(43) Pub. Date: Apr. 20, 2006

(54) RSA with personalized secret

(76) Inventor: Jing-Jang Hwang, Kwei-Shan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/171,439

(22) Filed: Jul. 1, 2005

Related U.S. Application Data
(60) Provisional application No. 60/585,232, filed on Jul. 2, 2004.

(51) Int. Cl. H04L 9/28; H04L 9/00; H04K 1/00

(52) U.S. Cl. 380/28; 380/44

(57) ABSTRACT

The present invention creates flexibility into the RSA cryptography. The goal is achieved by allowing a user to select a personalized secret such as a password to derive an exponent that functions like a leading part of the RSA private key, and by further allowing the user to discretionarily change the selection without resorting to a regeneration of the public/private key pair. The invention also includes methods and cryptosystems of using a personalized secret and a crypto-key trio to produce and validate a digital signature. Exchanging a symmetric crypto key between two communication parties is one further application utilizing the devised techniques for the crypto-key generation, update, and validation.

This application claims a Priority Filing Date of Jul. 2, 2004 benefited from a previously filed Provisional Application 60/585,232 entitled “Designs and Applications of Personalized Private Subkey Based on Public-Key Cryptography” by a common inventor of this Patent Application.

### BACKGROUND OF THE INVENTION

1. Field of the Invention

The present invention relates to cryptographic methods, techniques, and systems including crypto-key generation and update, digital signature, data encryption, and data decryption.

2. Description of the Prior Art

Cryptosystems use crypto keys for cryptographic computation. In the cryptosystems based on asymmetric cryptography such as RSA (Rivest-Shamir-Adleman), crypto keys are generated in pairs of a public key and a private key. The way of using the public/private key pair defines two applications. One uses the private key as a signature key to produce a digital signature on a digital message and the public key as a verification key for verifying whether a value is a valid digital signature. The other uses the public key as an encryption key to encrypt a plaintext into a cipher and the private key as a decryption key to decrypt the cipher back to the plaintext.

Users who are a signatory performing digital signature must keep their signature private key confidential. Also, users who are a cipher receiver must keep their decryption private key confidential. The private key is a secret. Disclosure of the public key must not reveal the secrecy of the private key, though the private key has a dependence on the public key. Due to this secrecy requirement, computational intractability of deriving the private key from the public key is vital to the security of asymmetric cryptosystems.

In the RSA scheme, computation is carried out with modular arithmetic using the product of two primes as the modulus. The computational intractability of deriving the private key from the pairing public key rests in part on the lack of an efficient algorithm for factoring the product back to the two primes. Nevertheless, the private key is not independent of the public key, because their relationship with the two secret primes. This relationship prohibits the private key from being chosen by a user at the discretion of the user. This relationship also imposes that the private key cannot be changed except by resorting to a regeneration of the public/private key pair.

The RSA cryptosystem is described in U.S. Pat. No. 4,405,823 and in the paper: Rivest, Shamir, and Adleman, “A Method for Obtaining Digital Signatures and Public-Key Cryptosystems,” Communications of the ACM, vol. 21 (1978), pp. 120-126. Several standards have been developed for teaching this asymmetric cryptography, including PKCS #1:RSA Cryptography Standard, November 1993 (v. 1.5) & June 2002 (v. 2.1) and IEEE Std 1363-2000: IEEE Standard Specification for Public-Key Cryptography, which are respectively available at the web site of RSA Laboratories and that of IEEE. These standards include descriptions on key generation, encryption, decryption, signature generation, signature verification, and other related techniques.

RSA computations always involve modular arithmetic. The definition on modular arithmetic is given here. If x and y are integers, then x is said to be congruent to y modulo a positive integer z, written x≡y (mod z), if z divides (x−y). The positive integer z is called the modulus of the congruence.

The RSA key generation process recommended in PKCS# 1 v.1.5 is summarized below:

(1) A positive integer e is chosen as the encryption exponent, also known as the public exponent.

(2) Two distinct odd primes p and q are randomly selected such that e is relatively prime to both p−1 and q−1.

(3) The public modulus is the product n=pq.

(4) The private exponent d is chosen such that both p−1 and q−1 divide de−1.

The RSA public exponent e and modulus n are used to encrypt a plaintext integer m, assumed less than n, to get a cipher integer c by computing
c≡m^{e}(mod n).
The private exponent d and modulus n are used to decrypt the cipher c back to the plaintext m by computing
m≡c^{d}(mod n).

In certain cryptosystems such as those built accordingly to the SSL/TLS (Secure Sockets Layer/Transport Layer Security) protocols, encryption with RSA is often combined with encryption using symmetric cryptography, creating a hybrid cryptosystem. In such a hybrid cryptosystem, one side of the communication encrypts a randomly generated secret with a RSA public key while the other side receives and decrypts the encrypted secret with a pairing RSA private key; subsequently, both sides use the same secret as a symmetric crypto key for confidential communications. The symmetric crypto key exchanged in this way is called a session key. For details, refer to RFC 2246 and other related documents at the web site of Internet Engineering Task Force.

The RSA private exponent d and modulus n are used to produce a digital signature. First, a digital message M is processed by a selected collision-resistant hash function to produce a digest on M, expressed as Hash(M). Next, the digital signature on M, expressed as signature(M), is obtained by computing
signature(M)≡Hash(M)^{d}(mod n).
The RSA public exponent e and modulus n are used to validate a value being a valid digital signature. Suppose that M∥SGN is received by a verifier, where M represents a digital message and SGN represents a value that is attached as a digital signature on M. The verifier first computes Hash(M) using the selected collision-resistant hash function, and decrypts SGN with the public key (e, n) by computing
SGN^{e}(mod n).
Next, the verifier compares Hash(M) with the decryption result. If the comparison yields an equal, then SGN is a valid digital signature.

Hash functions are used in producing a digital signature. Hash functions are deterministic, meaning that the output is completely determined by the input. The hash function used in digital signature should generally be collision-resistant. This means that it is infeasible to find two distinct inputs that could produce the same output by the hash function. A collision-resistant hash function also has the desired property of being one-way; this means that given an output, it is infeasible to find an input whose hash is the specified output. In addition, the hash function should be a mask generation function with pseudorandom output: Given one part of the output but not the input, it should be infeasible to predict another part of the output. Six hash functions possessing these properties are suggested for various implementations in PKCS #1 v.2.1: MD2, MD5, SHA-1, SHA-256, SHA-384, and SHA-512.

According to the convention of the RSA cryptography, outputs of collision-resistant hash functions are encoded as a non-negative integer; for example, in
signature(M)≡(Hash(M))^{d}(mod n),
Hash(M) is a non-negative integer. Also, the private exponent d and the pair (d, n) are interchangeably called the private key. It is understood that RSA computations with the private exponent d is always a modulo n computation. This patent specification follows such conventions.

Application of asymmetric cryptography raises one concern. How can a public-key's user such as a verifier of digital signatures or a sender of confidential messages know that the public key in use is authentic? A cheater may cheat the verifier to validate a false digital signature as valid or cheat the message sender to encrypt confidential messages with a fictitious public key. Public-key certificates, also known as digital certificates, provide a solution.

Abstractly, a public-key certificate consists of three main components: a public key, an entity's identifier, and a certification authority's digital signature. Thus, a public-key certificate provides a binding between a public key and an identification of an entity and ensures that the public key belongs to the identified entity and that the entity possesses the pairing private key. By validating the certification authority's digital signature, users of the public key prove this binding. A certification authority, or CA, is a trusted party who certifies and issues public-key certificates. Revoking certain certificates and publishing the revoked certificates are also part of a CA's duties.

Asymmetric cryptosystems have been around for a long time, but have not been as widely applied as perceived. For example, user login with password where no public/private key pairs are used remains common. One reason is that the infrastructure of ensuring a certificate being valid is cumbersome to build and operate. The task becomes more complicated due to the inflexibility on changing the secret private key. Thus, there exists a need to alleviate the complication.

In certain circumstances, a digital message may need to be signed by several signatories and then verified by one verifier alone. Multisignature techniques were invented to meet the need. See Colin Boyd, “Digital Multisignatures,” in Cryptography and Coding (H. J. Becker and F. C. Piper Eds.), Oxford University Press, 1989, pp. 241-246. In U.S. Pat. No. 6,209,091, two multisignature systems are described: (1) a multiplicative scheme with sequential partial signing, and (2) an additive scheme with asynchronous partial signing. These and other related works result in an advantage. The private key is not needed for the signature computation because the digital signature is computed from a plurality of partial signatures, each of which is computed, respectively, from the digital message and a signature subkey. The private key never exists after the signature subkeys have been derived from it. Therefore, the secrecy of the private key is well protected.

Extended from the multisignature techniques, split-private-key cryptosystems were invented and developed by Ravi Ganesan and others. See U.S. Pat. Nos. 5,535,276, 5,557,678, 5,905,799, etc., where the private exponent key is divided into a first private key portion and a second private key portion. With the two private key portions, asymmetric cryptosystems have at least two benefits. Firstly, dividing the secret into two portions and separately safeguarding each portion strengthens the protection for the secrecy of the private key. Secondly, the user is allowed to use a short secret key while the underlying cryptosystem uses a long but secure private key. The first benefit is a classical wisdom on protecting secrecy. The second benefit is significant, in part because attacks on short RSA secret exponents are feasible as discovered by M. J. Wiener in “Cryptanalysis of Short RSA Secret Exponents, IEEE Trans. on Information Theory, May, 1990, vol. 36, no. 3, pp. 553-558.” Recent cryptanalysis on short RSA private exponents includes a technique discovered by Dan Boneh and Glenn Durfee in “Cryptanalysis of RSA with Private Key d Less Than N^{0.292}, IEEE Trans. on Information Theory, July, 2000, vol. 46, no. 4, pp. 1339-1349.”

The multisignature and split-private-key techniques add values to the RSA theory on the aspects of security and user convenience. The inflexibility on changing the private secret remains unresolved, however. In order to change the private key portions, users may resort to either one of two ways: the first by which the original private key is recovered from the two portions and then divided again and the second by which a new public/private key pair is generated and subsequently the new private key is divided. However, it is undesirable to recover the original private key because this action contradicts the principle of separating the secrecy and needs special measures to protect the secrecy from disclosure during the recovery process. It should also be avoided to regenerate a public/private key pair, because such a task is more complicated than generating a first-time public/private key pair due to the added effort of revoking the replaced public-key certificate.

Therefore, there remains a need to improve the split private key techniques on the aspect of changing the private key portions in a more efficient and flexible manner.

### SUMMARY OF THE INVENTION

To achieve these and other advantages and in order to overcome the disadvantages of the conventional method in accordance with the purpose of the invention as embodied and broadly described herein, the present invention provides a method for generating and updating an asymmetric crypto key.

The method produces a modulus, a public exponent, a first private exponent, and a second private exponent as one asymmetric crypto key like the one generated according to the split-private-key cryptography but with two distinct features. First, the first private exponent can be independently derived from a personalized secret, meaning that the generation of this exponent can be carried out without a dependence on information related to other parts of the key generation task, and also meaning that the secret is a selection at the personal discretion of the exponent's user. The second distinct feature is the accompanying update process. By changing the secret to a new selection, the update process derives a new first private exponent and accordingly replaces the second private exponent with an updated value while keeping the modulus and the public exponent unchanged. The significance of these two distinct features will be clear from the specification of this patent application.

In the present invention, the key generation method consists of three major tasks: (1) using a secret as input to a first function to produce a first private exponent; (2) obtaining two odd primes p and q and using these two primes in a RSA public/private key pair generation process to generate a public/private key pair, in which the public key is composed of a modulus and a public exponent; and (3) using the first private exponent from the first task and three values from the second task, which are the two primes p and q and the private key, as four inputs to a second function to produce a second private exponent.

This key generation process produces three outputs: (1) the modulus, which is one output of the second task; (2) the public exponent, which is another output of the second task; and (3) the second private exponent, which is the output of the third task. The three outputs are expressed as n, e, and v, respectively. Upon completion of the key generation, persistent memories are provided to store these three outputs. Grouped together as the public key, the modulus n and the public exponent e are made accessible to processors that validate signatures or encipher messages. The second private exponent v, on the other hand, is made accessible only to processors that take part in producing digital signatures or deciphering ciphers.

The first private exponent, expressed as u, is not an output of the key generation process. This exponent is derived from the secret upon demand for producing a digital signature or deciphering a cipher. Providing a persistent memory to store this exponent is not necessary. Special measures can be applied to further prevent it from being stored in persistent memory; for example, it can be deleted from each memory associated with computations whenever producing a digital signature or deciphering a cipher is terminated.

The secret, which is the input to the first function in the first task, is expressed as s. The private key, which is one result of the RSA key pair generation in the second task, is expressed as d. In the conventional RSA signature and decryption computations, the private key d is an essential input. This private key will not be needed in the signature and decryption computations performed according to the present invention; the second private exponent v and the secret s replace it.

The second private exponent, the public exponent, and the modulus can be grouped together as a crypto-key trio. The trio is also called a user crypto-key trio to emphasize its association with a user.

The secret to derive the first private exponent can be a personalized secret such as a user-chosen password or user selectable password. The term “personalized secret” is adopted in order to emphasize its difference from “private key”, which is not a personal choice but a secret output from a public/private key pair generation process of RSA. Selection of the personalized secret is very flexible, as discussed later in this specification.

Like in the conventional RSA cryptosystems, the two primes p and q are confidential data. They must be destroyed upon the termination of the key generation process or be kept strictly confidential thereafter.

The present invention aims to obviate the disadvantage caused by the rigidity on generating and changing the RSA public/private key pair. This is achieved by allowing a user to discretionarily select a secret such as a password to derive an exponent that functions like a leading part of the RSA private key, and by further allowing the user to discretionarily change the selection without resorting to a regeneration of the public/private key pair.

The present invention also provides a method for producing a digital signature using a personalized secret. Digital signature is a major application with asymmetric cryptography in which a private key is used as a signature private key.

In the method, a personalized secret is one input to the computation of digital signature. A digital message and the personalized secret input such as a password input are received from a user who requests for producing a digital signature on the digital message. The three components of a crypto-key trio are retrieved from their storage place. A digital signature on the digital message is produced using the user input and the retrieved crypto-key trio. Next, the digital signature produced is validated. Either the personalized secret input or at least one component of the retrieved crypto key trio is false, if the digital signature is invalid.

The present invention additionally provides a method of indirectly validating a user input as a valid personalized secret. The method first produces and then validates a digital signature. The digital signature is invalid when the user input mismatches the personalized secret or at least one component of the retrieved crypto-key trio is incorrect. The former is more likely, because the personalized secret input, in most implementations, comprises a human entry. In contrast, the user crypto-key trio is stored in computer-readable medium and, in many implementations, is kept in a personal device; therefore, producing an invalid digital signature due to a false crypto-key trio is much less likely. As a result of the indirect validation, none of the personalized secret and its derivatives such as its hash digests or its ciphers is used as the verification information for input validation. Providing a persistent memory to store certain derivatives of the personalized secret becomes unnecessary. This strengthens confidentiality protection of the personalized secret.

The present invention further provides a process integrating a session-key exchange process with crypto-key generation and validation techniques. One side or first party holds the “hidden” decryption private key. The term “hidden” is used to emphasize that the private key never exists in a device after the second private exponent is produced, because it is replaced by a first and second user secrets—the personalized secret and the second private exponent. The other side or second party creates a random number, considers it as a session key, and encrypts the session key using the public key pairing with the “hidden” private key. The second party then sends the first party the encrypted session key. The first party receives a personalized secret input from the holder of the “hidden” decryption private key, retrieves a crypto-key trio consisting of a second private exponent, a modulus, and a public exponent from accessible persistent memories. Next, the first party validates the personalized secret input and the retrieved crypto-key trio. By applying the techniques described earlier, the validation is carried out by producing and validating a digital signature on a digital message. Next, the first party uses the personalized secret to produce a first private exponent and then uses the first and second private exponents as two decryption subkeys to decipher the received encrypted session key to obtain the session key. Upon success of exchanging a session key, both sides use this identical session key for confidential communication with each other.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a diagram illustrating a method for generating an asymmetric crypto key according to an embodiment of the present invention;

FIG. 1B is a flowchart illustrating a method for generating an asymmetric crypto key according to an embodiment of the present invention;

FIG. 2 is a flowchart illustrating a method for updating an asymmetric crypto key according to an embodiment of the present invention;

FIG. 3 is a flowchart illustrating a method for updating an asymmetric crypto key utilizing two processors to collaborate in carrying out the update according to an embodiment of the present invention;

FIG. 4 is a flowchart illustrating a method for producing a digital signature according to an embodiment of the present invention;

FIG. 5 is a flowchart illustrating a method for producing a digital signature where computing the digital signature employs a proactive processor and a reactive processor according to an embodiment of the present invention; and

FIG. 6 is a diagram illustrating a process integrating a session-key exchange process with crypto-key generation and validation techniques according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

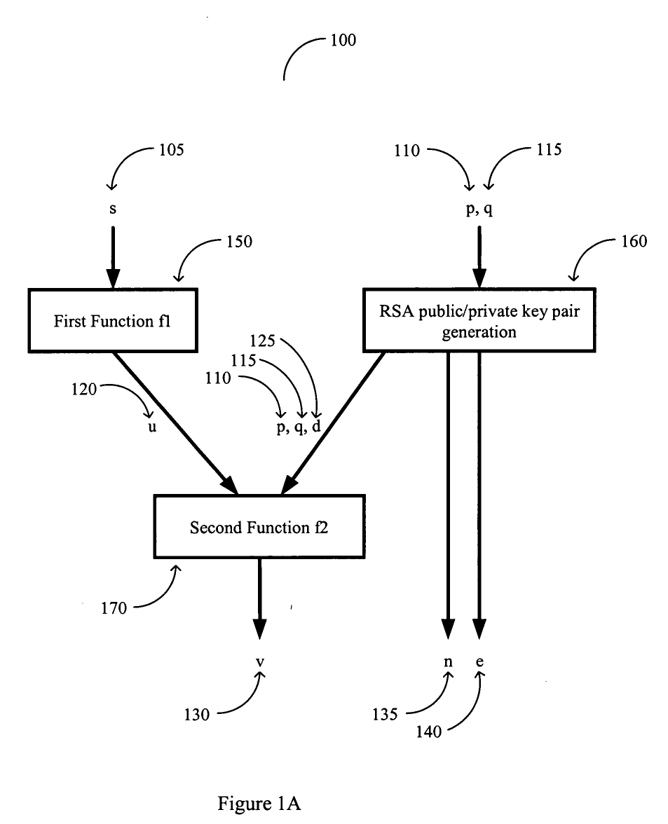

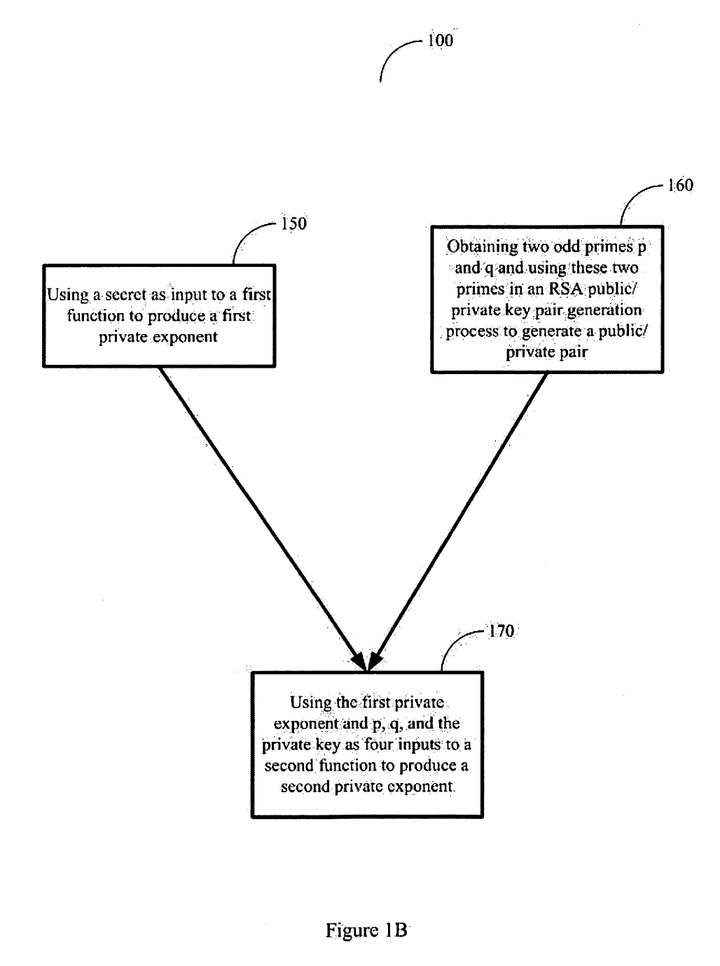

Refer to FIG. 1A, which is a diagram illustrating a method for generating an asymmetric crypto key according to an embodiment of the present invention and to FIG. 1B, which is a flowchart illustrating a method for generating an asymmetric crypto key according to an embodiment of the present invention.

The figures summarize the three tasks and their input-output dependences in the key generation process. The first function used to produce the first private exponent u in the first task is expressed as f1, while the second function used to produce the second private exponent v in the third task is expressed as f2. These and other notations in the figures are consistently used to denote the same meaning throughout this patent specification.

In the present invention as shown in FIGS. 1A and 1B, the key generation method 100 consists of three major tasks: (1) using a secret 105 as input to a first function to produce a first private exponent 120 in step 150; (2) obtaining two odd primes p 110 and q 115 and using these two primes in a RSA public/private key pair generation process to generate a public/private key pair, in which the public key is composed of a modulus 135 and a public exponent 140 in step 160; and (3) using the first private exponent 120 from the first task and three values from the second task, which are the two primes p 110 and q 115 and the private key 125, as four inputs to a second function to produce a second private exponent 130 in step 170.

This key generation process produces three outputs: (1) the modulus 135, which is one output of the second task; (2) the public exponent 140, which is another output of the second task; and (3) the second private exponent 130, which is the output of the third task. The three outputs are expressed as n, e, and v, respectively. Upon completion of the key generation, persistent memories are provided to store these three outputs. Grouped together as the public key, the modulus n and the public exponent e are made accessible to processors that validate signatures or encipher messages. The second private exponent v, on the other hand, is made accessible only to processors that take part in producing digital signatures or deciphering ciphers.

The first private exponent, expressed as u, is not an output of the key generation process. This exponent is derived from the secret upon demand for producing a digital signature or deciphering a cipher. Providing a persistent memory to store this exponent is not necessary. Special measures can be applied to further prevent it from being stored in persistent memory; for example, it can be deleted from each memory associated with computations whenever producing a digital signature or deciphering a cipher is terminated.

The secret, which is the input to the first function in the first task, is expressed as s. The private key, which is one result of the RSA key pair generation in the second task, is expressed as d. This private key will not be needed in the signature and decryption computations performed according to the present invention; the second private exponent v and the secret s replace it.

The secret to derive the first private exponent can be a personalized secret such as a user-chosen password or user selectable password. The term “personalized secret” is adopted in order to emphasize its difference from “private key”, which is not a personal choice but a secret output from a public/private key pair generation process of RSA.

The two primes p and q are confidential data. They must be destroyed upon the termination of the key generation process or be kept strictly confidential thereafter.

The two functions f1 and f2 used in the key generation process are vital for achieving the mentioned new features. One configuration of the function pair is the following:

f1(x)=H(x);

f2(y, h, k, z)=c×LCM(h−1, k−1)+z+−y)mod LCM(h−1, k−1)).

In the configuration, x, y, h, k, and z respectively denote a value instance of s, u, p, q and d. To avoid confusion, the input variables received by f1 and f2 are replaced with new symbols.

The parameter c in the configuration of f2 is a non-negative integer. LCM stands for Least Common Multiple and H stands for a collision-resistant hash function. The reasons for configuring f1 and f2 as such are explained below.

Using f1 and f2 in the key generation process, the following two identities are satisfied by the defined elements: s, u, v, p, q, and d.

First Identity: u=H(s);

Second Identity: v=c×LCM(p−1, q−1)+d+((−u)mod LCM(p−1, q−1)).

Besides being used in the key generation process, the first function f1 is used to derive the first private exponent again upon demand for producing a digital signature or deciphering a cipher. The second function f2 is used only in the key generation process.

The function H is a collision-resistant hash function, e.g. SHA-1, producing a bit string that is encoded as a non-negative integer. The fundamental requirement for configuring f1 is to satisfy the property of collision-resistance, which means that it must be infeasible to find two different secrets to produce one identical first private exponent. The property of computational intractability, also satisfied by collision-resistant hash functions, is not strictly required for the function f1 considering that the output of f1 exists only at an instant moment in the middle of computations. Computational intractability, however, strengthens the admissibility on non-repudiation claimed by digital signature. Unable to trace input from output, a user cannot perform digital signature unless the user knows the secret to derive the first private exponent.

By configuring f1 to satisfy collision-resistance and computational intractability, a digital signature becomes a more persuasive piece of evidence to resolve a dispute when the signatory is able to present a correct secret to derive the first private exponent and then subsequently duplicate the digital signature.

Using a collision-resistant function in configuring f1 effectively expands the space containing all possible instances of the selected secret s. For example, SHA-1 accepts a message of any length<2⁶⁴ bits as an input. (See: Federal Information Standards Publication 180-1, Secure Hash Standard, 1995.) A message of length 2⁶⁴ is very long. By configuring f1 with such capability, the personalized secret can be defined as a concatenation of several chosen secrets, e.g. s=s₁∥s₂∥ . . . ∥sₘ, thereby the selection of the personalized secret is very flexible.

The flexibility on selecting a personalized secret as input to the first function f1 to derive the first private exponent creates various beneficial application scenarios. For example, the secret can be a user-chosen password or user selectable password and thereby enabling devise a new method for producing digital signatures using password as the primary input. As a second example, the secret can be a concatenation of a user-chosen password and a device-specific code such that performing the digital signature is restricted to a specific device. Other application scenarios are also possible.

The second function f2 involves modulo LCM(h−1, k−1) in modular arithmetic, where LCM(h−1, k−1) denotes the least common multiple of h−1 and k−1. The use of modulo LCM(h−1, k−1) in the mathematical expression of f2 is to create the identity:

Third Identity: d≡u+v (mod LCM(p−1, q−1)).

This identity is used in part to prove the properties satisfied by u and v. See the proof later.

There is one more reason for including modular arithmetic in f2. Using the mathematical expression
z+((−y)mod LCM(h−1, k−1)),
in configuring f2 extends the range of y: The input variable y is capable of receiving an arbitrary positive integer, either less or greater than z. This way of configuring f2 renders flexibility to the creation of u, which is the output of f1 and assigned to the input variable y received by f2. Consequently, u can be a positive integer with an arbitrary magnitude.

In some environments, it may be desired to make u large. RSA-type cryptographic computations using u as an exponent are a computation involving modulo exponential expressions. Such computations increase computational time exponentially. Thus, guessing u or the secret s to derive u becomes time consuming when u is large.

As defined, u is an output of f1. The function f1 can be further configured by adding a non-negative constant integer b to a collision-resistant hash function H; i.e.:
f1(x)=H(x)+b.

In certain circumstances, a large constant b is selected. By such, f1 produces a large u. It is obvious that the first function f1 so configured remains a collision-resistant hash function. The configuration
f1(x)=H(x)
includes the case
f1(x)=H(x)+b.

In the first term c×LCM(h−1, k−1) in the configuration of f2, c represents a non-negative constant integer. The parameter c is set to zero in most cases but set to a positive integer in a few occasions, according to the need of updating the crypto key as discussed later in this specification.

The Third Identity remains true when the term c×LCM(h−1, k−1) is added into the configuration of the second function f2. Furthermore, the Fourth Identity below is an obvious consequence of the Third Identity:

Fourth Identity: f1(s)+v=d+a×LCM(p−1, q−1), where a is a non-negative integer.

The following proof establishes two mathematical identities, named the Fifth and Sixth Identities, satisfied by the defined elements: s, v, n, e, and f1.

Fifth Identity: Hash(M)≡(Hash(M)^{f1(s)}×Hash(M)^{v})^{e}(mod n)

Sixth Identity: m=(m^{e})^{f1(s)}×(m^{e})^{v}(mod n)

The Fifth Identity holds for all instances of M, which represents a given digital message. The Sixth Identity holds for all instances of m, which is a non-negative integer less than n.

In the Fifth Identity, “Hash” represents a collision-resistant hash function. This function may be different from the function H adopted in the configuration of the first function f1.

Proof of the Fifth Identity is given below.

Like the proof in the original RSA paper, the proof herein is based upon a theorem established by Fermat: For any integer r relatively prime to a positive integer t,
1≡r^{φ(t)}(mod t).
Here φ(t) is the Euler φ function, which counts the number of positive integers less than and relatively prime to t.

For the prime number p,
φ(p)=p−1.
For any instance of M such that p does not divide Hash(M), it is true that
1≡Hash(M)^{p-1}(mod p),
as deduced from the Fermat's Theorem. Since (p−1) divides LCM(p−1, q−1),
1≡Hash(M)^{LCM(p-1, q-1)}(mod p)
holds if p does not divide Hash(M). Therefore,
Hash(M)≡Hash(M)^{1+wLCM(p-1, q-1)}(mod p)
holds for the case p does not divide Hash(M), where the multiplier w in the exponent denotes an arbitrary non-negative integer.

If p does divide Hash(M), then it is trivially true that
0≡Hash(M)(mod p)
and
Hash(M)≡Hash(M)^{1+wLCM(p-1, q-1)}(mod p),
since each side is congruent to zero.

Therefore, in all cases, the following Seventh Identity holds for all instances of M:

Seventh Identity: Hash(M)≡Hash(M)^{1+wLCM(p-1, q-1)}(mod p).

Arguing similarly for q, which is also a prime, yields the Eighth Identity:

Eighth Identity: Hash(M)≡(Hash(M))^{1+wLCM(p-1, q-1)}(mod q).

Due to n=pq and the fact that p and q are relatively prime to each other, together these last two identities, Seventh and Eighth, implies that the following Ninth Identity holds for all instances of M:

Ninth Identity: Hash(M)≡Hash(M)^{1+wLCM(p-1, q-1)}(mod n).

Let us restate the Fourth Identity here:
f1(s)+v=d+a×LCM(p−1, q−1),
where a is a non-negative integer. Recalling further that d, e, and n are generated according to the RSA public/private key pair generation, it follows that
1≡d×e(mod LCM(p−1, q−1)),
i.e.
d×e=1+g×LCM(p−1, q−1)
for a positive integer g.

Now we are ready to prove the Fifth Identity.

The right side of the identity is
(Hash(M)^{f1(s)}×Hash(M)^{v})^{e}(mod n),
which is equal to:
modulo n Hash(M)^{(f1(s)+v)e}.

Let us focus on the exponent (f1(s)+v)e. This exponent equals:
(d+a×LCM(p−1, q−1))×e=d×e+a×LCM(p−1, q−1)×e=1+g′×LCM(p−1, q−1),
where g′=g+axe is a positive integer.

Therefore,
(Hash(M)^{f1(s)}×Hash(M)^{v})^{e}=Hash(M)^{1+g′LCM(p-1,q-1)}(mod n)≡Hash(M)
holds, according to the proven Ninth Identity. This concludes the proof of the Fifth Identity.

Now let us prove the Sixth Identity. The right side of the identity is
(m^{e})^{f1(s)}×m^{e})^{v}(mod n),
which is congruent to
m^{e(f1(s)+v)}(mod n).
Again,
e(f1(s)+v)=1+g′×LCM(p−1, q−1),
where g′ is a positive integer. Therefore,
m≡(m^{e})f1(s)×(m^{e})^{v}(mod n),
according to the proven Ninth Identity. This concludes the proof of the Sixth Identity.

The above proof holds when LCM(p−1, q−1) is replaced by (p−1)×(q−1), which is the number of positive integers less than and relatively prime to n=p×q and is equal to φ(n) according to the definition of the Euler φ function. Moreover, the proof does not depend on how f1 is configured. As discussed earlier,
f1(x)=H(x)+b
is a collision-resistant function satisfying the requirement for the first function f1, given that H(x) is a collision-resistant hash function and b is a non-negative integer. Therefore, the configuration of the first and second functions f1 and f2 can be substituted with the expressions below:

f1(x)=H(x)+b, where H and b are as defined; and

f2(y, h, k, z)=c×φ(h×k)+z+((−y)mod φ(h×k)), where c is a non-negative integer and φ is the Euler φ function.

The Fifth Identity established in an earlier part is the basis for producing and validating a digital signature. A digital signature on a digital message M is defined as
signature(M)≡Hash(M)^{f1(s)}×Hash(M)^{v}(mod n),
which is equal to:
((Hash(M)^{f1(s)}mod n)×(Hash(M)^{v} mod n))mod n.
Here the two modulo n exponential expressions,
Hash(M)^{f1(s)} mod n
and
Hash(M)^{v} mod n,
are used to compute two partial digital signatures on M. The tasks of computing the two partial digital signatures can be carried out on one single processor or on two processors.

To validate a given value, expressed as SGN, as a valid digital signature on M, we verify whether
Hash(M)=(SGN)^{e}(mod n)
is true.

The computation of digital signature as described above uses two secrets from the signatory: the personalized secret and the second private exponent, which are respectively called a first user secret and a second user secret. Also, the computation uses a first collision-resistant hash function f1 and a second collision-resistant hash function Hash. The two collision-resistant functions can be identical or different.

The Sixth Identity is the basis for data encryption and decryption. As in the conventional RSA cryptosystems, the public exponent e and the modulus n are used in enciphering a message m, assumed as a positive integer less than n. The encryption computation is defined by
c≡m^{e}(mod n).
According to the present invention, the decryption is a joint effort with two private exponents. In mathematics,
m≡c^{f1(s)}×c^{v}(mod n).
Also, the plaintext integer m can be recovered by modulo n multiplication of two partial decryption results:
c^{f1(s)} mod n
and
c^{v} mod n.
The tasks of computing the two partial decryption results can be carried out either on two processors or on a single processor.

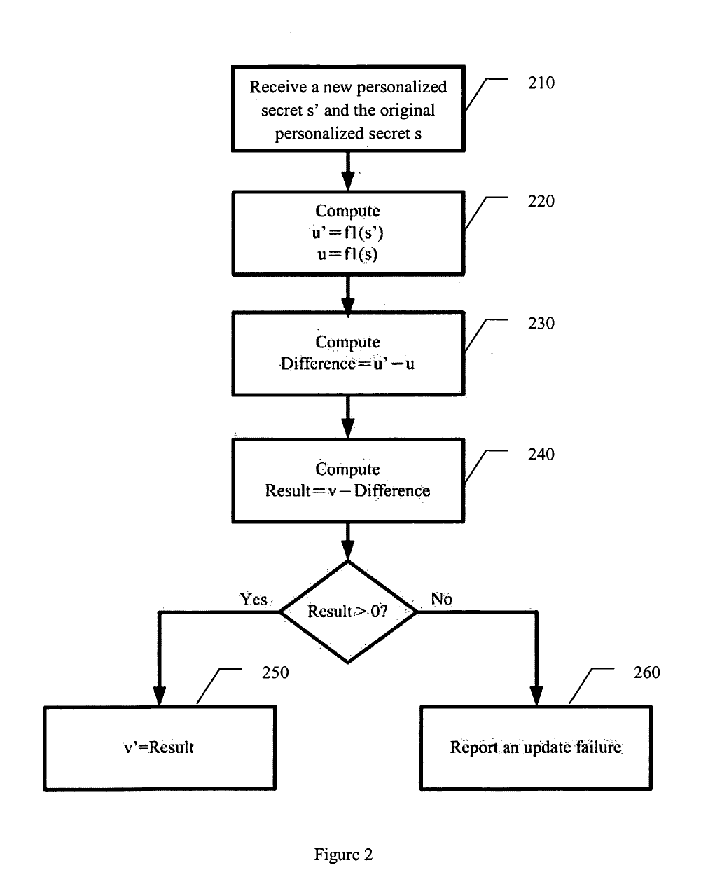

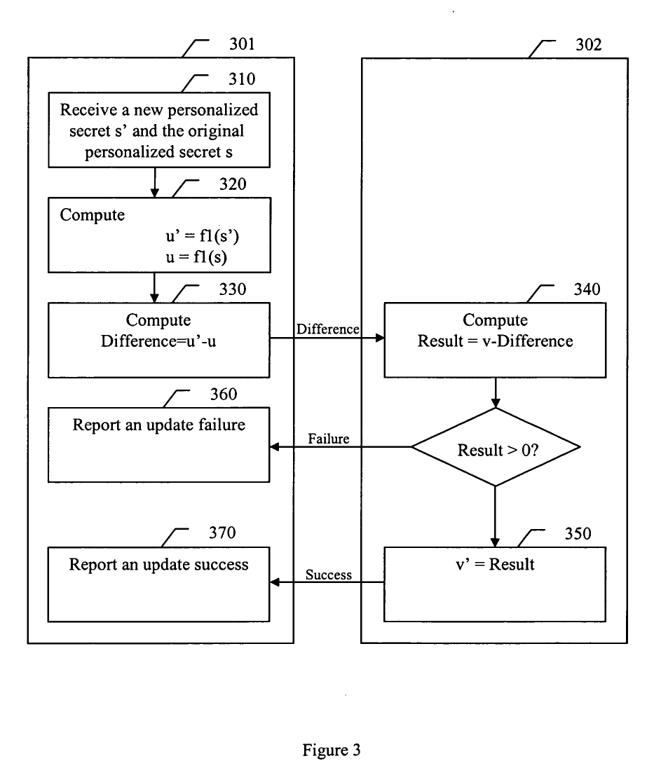

Refer to FIG. 2, which is a flowchart illustrating a method for updating an asymmetric crypto key according to an embodiment of the present invention and to FIG. 3, which is a flowchart illustrating a method for updating an asymmetric crypto key utilizing two processors to collaborate in carrying out the update according to an embodiment of the present invention.

One distinguishable feature of the present invention is that the asymmetric crypto key can be updated with a less costly effort than a regeneration of the crypto key. The update is triggered by a new selection on the personalized secret, allowing the user to derive a new first private exponent and accordingly update the second private exponent while keeping the public key, i.e. the public exponent and the modulus, unchanged.

The update is not obvious, because the three core elements, p, q, and d are not available to the update.

The update can be described as a process comprising the following steps: (1) receiving a new personalized secret and the original secret (i.e. the original personalized secret or the personalized secret presently in use) in step 210, (2) using the new personalized secret as input to the first function f1 to produce a new first private exponent and the original secret as input to f1 to derive the original first private exponent in step 220, (3) subtracting the original first private exponent from the new first private exponent to obtain a difference in step 230, (4) subtracting the difference from the second private exponent to obtain a result in step 240, (5) replacing the second private exponent with the result as the updated second private exponent when the result is positive in step 250, and (6) reporting a failure when the result is non-positive in step 260.

The first and second private exponents before and after the update satisfy this equation:
u′+v′=u+v,
where u′ and v′ represent the updated counterparts. Deduced from this equation, the Third and Fourth Identities remain true after the update. Therefore, the Fifth and Sixth Identities, which are the basis for both digital signature and data encryption applications, remain true.

In FIG. 3, one processor 301 playing a proactive role accepts the personalized secret presently in use and a new personalized secret 310 and obtains the difference as defined in step 330, while the other processor 302 playing a reactive role updates the second private exponent 350. This modification is necessary for some implementations, when it is intended to separate the use of the personalized secret and the second private exponent in two processors. Separately safeguarding each of the two secrets—the personalized secret and the second private exponent—helps protect the security of the cryptosystem. The update is then reported as a failure 360 or a success 370.

The above update process can be further modified. It may be needed to add a step on validating the received original secret, i.e. the personalized secret before the change. Validating a digital signature produced from the received secret can do this.

There appears one deficiency in the update process. The result in step 340 must be positive otherwise a failure occurs. The term
c×LCM(h−1, k−1)
in the configuration of f2 is designed to overcome this deficiency. With an adequate positive integer c, the second private exponent so produced is guaranteed greater than the absolute value of the difference between the new first private exponent and the original first private exponent, where the absolute value of the difference is the difference itself when the difference is positive and is the negative of the difference when the difference is non-positive. The guarantee is proven below. By the configuration
f1(x)=H(x), the absolute value of the difference is certainly less than the maximum of
H(x₁)−H(x₂)
for any two instances of x₁ and x₂. Given a selection for the function H, this maximum is a known constant. Therefore, we can set the parameter c to a positive integer such that
c×LCM(p−1, q−1)
is greater than this maximum. Therefore, subtracting the difference from the second private exponent, which is larger than
c×LCM(p−1, q−1),
always yields a positive result.

Now suppose that f1 is configured as a commonly known collision-resistant hash function such as MD2, MD5, SHA-180, SHA-256, SHA-384, and SHA-512. With such a configuration for f1, the update process as described will very unlikely report a failure even when the parameter c is set to zero. According to the current practices on RSA, the private key d and LCM(p−1, q−1) are very likely a positive integer with a bit size much larger than 512. By the key generation process,
v=f2(f1(s), p, q, d)=d+((−f1(s))mod LCM(p−1, q−1))=d−f1(s).
Thereby, subtracting f1(s) from d yields a positive integer very close to d because f1(s) is much less than d. Suppose that d is an integer with a magnitude about 2¹⁰²⁴. Then the second private exponent v, in this case, is a number about the magnitude of 2¹⁰²³. The difference
f1(x₁)−f1(x₂)
is a value less than 2⁵¹² according to the configuration for f1. Subtracting a value less than 2⁵¹² from a value about the magnitude of 2¹⁰²³ produces a positive result. Due to
2¹⁰²³=2⁵¹²×2⁵¹¹,
the subtraction can be repeated a great number of times, at least about 2⁵¹¹ times, before the result becomes non-positive.

Now suppose that
f1(x)=H(x)+b.
With a big b, the derived first exponent u may be greater than or close to the private key d and thereby the resulting second private exponent v may not be a value with a magnitude as large as discussed in the above. It cannot be guaranteed that the update process as illustrated in FIG. 2 or FIG. 3 always produces a positive result, unless adding a positive term c×LCM(p−1, q−1) into the configuration of f2 such that the resulting second private exponent v is sufficiently large.

The reason for adding a big b into the configuration of f1 is to increase the time for signature or decryption computations, and, as a consequence, harden the guessing attack. This is an extremely cautious measure, however. In most applications, separately safeguarding each of the two secrets—the personalized secret and the second private exponent—would be adequate for security protection. Adding a big b as mentioned is one option that can be adopted for implementing extremely secure cryptosystems.

As described, selection of the personalized secret is flexible. The selection may include a first part that is a human-entry secret such as a user-chosen password or a PIN (Personal Identification Number) and a second part that is an automatically readable secret such as a device-specific code or a random-number secret stored in computer readable memories. The selection may include only one of either the first part or the second part.

Representing the personalized secret, an input is needed in producing a digital signature. Such an input is called a personalized secret input. The personalized secret input can be validated via validating the produced digital signature. Accordingly, none of the personalized secret and its derivatives such as its hash digests or its ciphers is used as the verification information for input validation. Derivatives of the personalized secret, in this context, are an output of a transformation for which this personalized secret is the single input.

In a broader sense, the second private exponent v is a derivative of the personalized secret s. But v is a transformation by f2, which receives three inputs p, q, and d, in addition to the personalized secret s,
v=f2(f1(s), p, q, d)=c×LCM(p−1, q−1)+d+((−f1(s))mod LCM(p−1, q−1)).
From this derivation, it is obvious that disclosure of v leaves the personalized secret s completely undetermined when the three secrets p, q, and d are unknown.

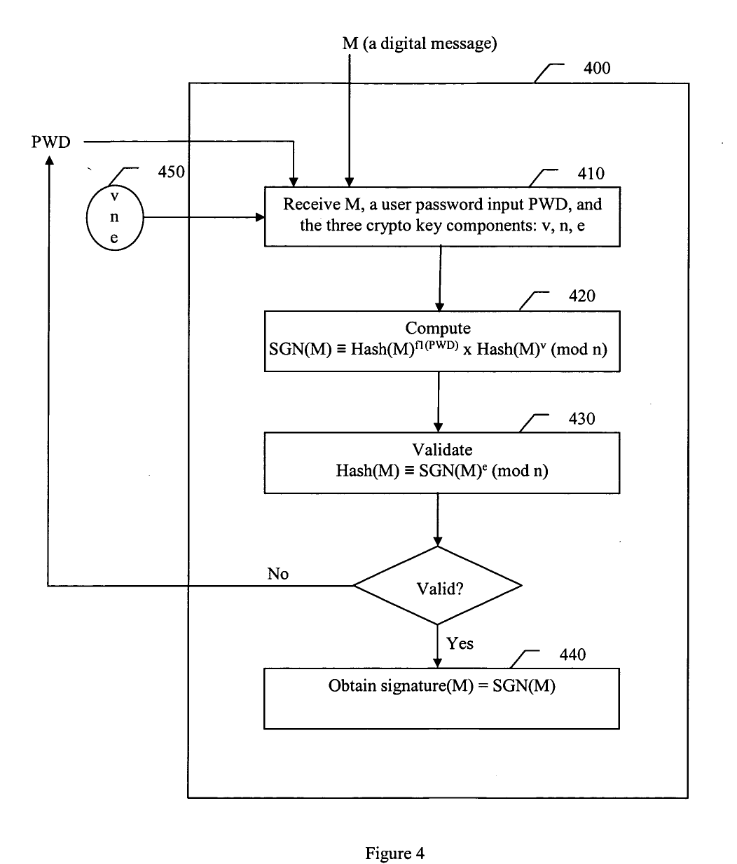

Refer to FIG. 4, which is a flowchart illustrating a method for producing a digital signature according to an embodiment of the present invention.

In this exemplary process 400, we assume that the personalized secret is a user-chosen password or user selectable password and we use PWD to denote a password input. In Step 410, a digital message M and a password input PWD are received from a user who requests for producing a digital signature on M, and the three crypto key components v, n, and e of a crypto-key trio are retrieved from their storage place 450. In Step 420,
SGN(M)≡Hash(M)^{f1(PWD)}×Hash(M)^{v}(mod n)
is computed. In Step 430, the congruence equality
Hash(M)≡SGN(M)^{e}(mod n)
is validated. Go to Step 440 to set
signature(M)=SGN(M),
when the result of Step 430 is an equal; otherwise, return to Step 410 if desired.

If the digital signature produced in Step 420 is invalid, either the password input PWD or at least one of the retrieved v, n, and e is false. The former is more likely, because v, n, and e are not human-entry data.

In FIG. 4, we assume that v, n, and e are kept in a storage device 450. There are several choices for such a device such as a RFID (Radio-Frequency Identification) tag, a memory card, a USB (Universal Serial Bus), or other memory devices. When the personalized secret is a human-entry secret such as a PIN or a user-chosen password, a portable device has the following benefit. Carrying such a device and carrying the personalized secret in the mind, a user is able to roam around the network and provide digital signatures upon demand.

Notably, the human-entry part of the personalized secret can be non-existent in any device. Furthermore, neither a hash digest nor a cipher of the personalized secret itself or its part must be kept in a persistent memory for input validation. These distinct features strengthen protecting confidentiality of the personalized secret.

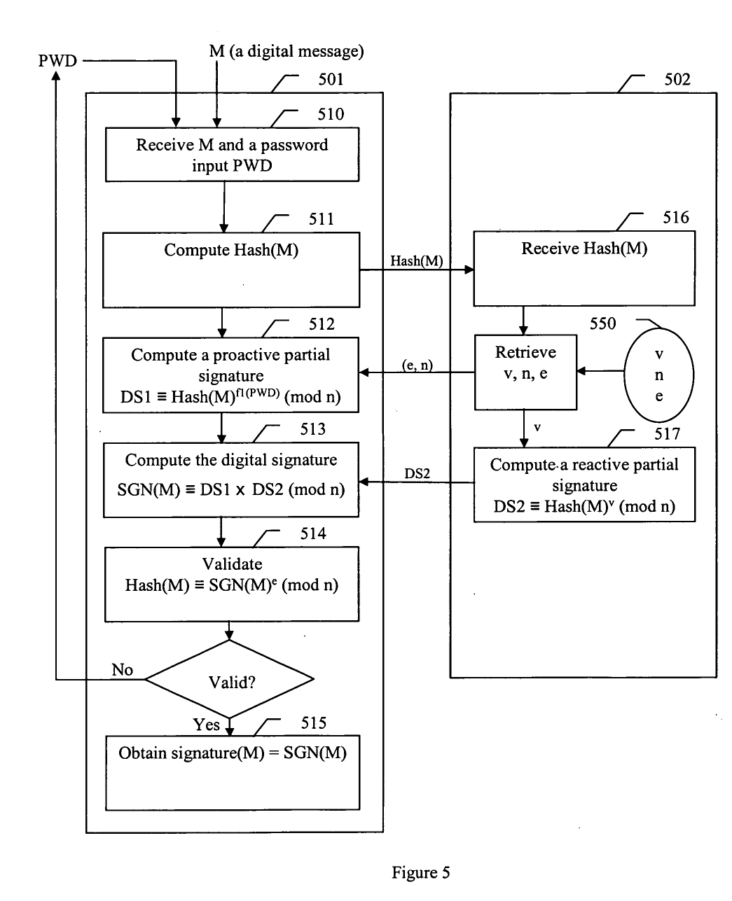

Refer to FIG. 5, which is a flowchart illustrating a method for producing a digital signature where computing the digital signature employs a proactive processor and a reactive processor according to an embodiment of the present invention. In this embodiment, the proactive processor leads the task of producing a digital signature while the reactive processor assisting in producing the digital signature. Details are described below.

The reactive processor 502 comprises built-in persistent memories 550 to keep a crypto-key trio of v, n, and e and is capable of computing partial digital signatures with v and n. The proactive processor 501 leads the task, receiving a personalized secret input, which is a password input PWD in this example, as well as a digital message M in step 510. The proactive processor computes Hash(M) in step 511 and sends it to the reactive processor as a signal to activate the reactive processor in step 516. The reactive processor then retrieves v, n, and e from its persistent memories 550, computes a partial digital signature on M, which is called a reactive partial digital signature and expressed as DS2(M) in step 517. The reactive processor responds to the proactive processor by sending n, e, and DS2(M) back to it. The proactive processor computes another partial digital signature, which is called a proactive partial digital signature and expressed as DS1(M) in step 512, and uses modulo n multiplication to multiply the two partial digital signatures to produce SGN(M), i.e.
SGN(M)≡DS1(M)×DS2(M)(mod n)
in step 513. Validation on SGN(M) follows by verifying the congruence equality
Hash(M)≡SGN(M)^{e}(mod n)
in step 514. The digital signature on M is obtained by setting
signature(M)=SGN(M)
in step 515, if SGN(M) is valid. Otherwise, the computation of the digital signature can be repeated if desired.

In one implementation, the reactive processor in this variation is built into an IC (Integrated Circuit) crypto card. This crypto card has one advantage over the conventional IC crypto card that carries a public/private key pair. The secret inside the conventional card is the private key, which must be kept strictly confidential. Loss of such a crypto card causes a severe threat to the security. In contrast, the crypto card implemented according to the present invention keeps, besides the public key, the second private exponent v, which is half of the secret, and loss of the half secret is much less of a concern.

It should be noted that production of a valid reactive partial digital signature could be restricted to a specific device where the second private exponent is stored. This adds additional security to the cryptosystem.

In both implementations according to FIGS. 4 and 5, the essential idea of replacing the private key by two secrets and separately safeguarding each is realized. This basic idea is of course built on a classical wisdom, but the novel modification as described significantly strengthens the security of the cryptosystem.

Digital signature is one of two major applications with asymmetric cryptography. The other one is encryption and decryption for confidentiality protection. A private key has two different but equally important usages: (1) as a signature private key, and (2) as a decryption private key. The above describes the application in digital signature where the “hidden” private key is a signature private key. The following describes the use of the “hidden” private key as a decryption private key in a process of exchanging a symmetric crypto key. Through the key exchange, the two sides of the communication obtain an identical symmetric crypto key, called a session key, for subsequent confidential communications.

One side of the communication represents the holder of the “hidden” decryption private key. According to the present invention, a personalized secret and a second private exponent replace the “hidden” decryption private key. The holder knows the personalized secret, for example, by remembering it in his/her human memory. To participate in exchanging a symmetric crypto key, the holder must provide the personalized secret as an input to the processor on his/her side. The processor also retrieves a crypto-key trio consisting of a second private exponent, a modulus, and a public exponent from an accessible persistent memory. The personalized secret input and the retrieved second private exponent can be validated prior to using them to replace the role of the “hidden” private key in performing decryption computation. The validation here is an application of the “indirect validation” technique as described in an earlier part of this patent application.

The modulus and the public exponent are also made available to the other side of the communication.

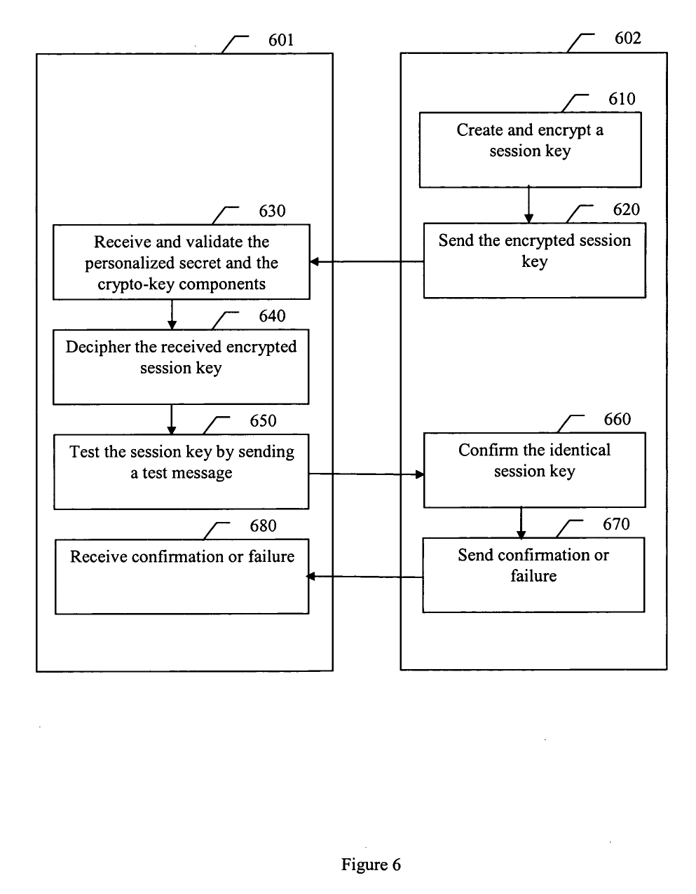

Refer to FIG. 6, which is a diagram illustrating a process integrating a session-key exchange process with the crypto-key generation and validation techniques of the present invention.

In the figure, 601 represents the side holding the “hidden” decryption private key while 602 represents the other side. Detail descriptions of the steps are given below.

Step 610: 602 creates a random number, considers it as a session key, and encrypts the session key with the public key, i.e. the public exponent and modulus. This step is initiated by Side 602 itself or activated by a request from Side 601.

Step 620: 602 sends 601 the encrypted session key.

Step 630: 601 receives a personalized secret input from the holder of the “hidden” decryption private key, retrieves a crypto-key trio consisting of a second private exponent, a modulus, and a public exponent from accessible persistent memories. Next, 601 validates the personalized secret input and the retrieved crypto-key trio. The validation is carried out with the same technique as described earlier: producing and validating a digital signature on a test message to determine the validity of the input and the retrieved trio. This step can be repeated if desired until a correct validation is obtained.

Step 640: 601 uses the personalized secret to produce a first private exponent and then uses the first and second private exponents as two decryption subkeys to decipher the received encrypted session key to obtain the session key.

Step 650: 601 encrypts a test message with the session key and sends the encrypted message and the message itself to 602.

Step 660: 602 deciphers the received encrypted message with the session key on its side and compares the result with the received message. 602 sends a confirmation in Step 670 that confirms that both sides now have the identical session key or indicates a failure which 601 receives in Step 680.

Upon success of exchanging a session key, both sides use this identical session key as a symmetric crypto key to encipher a plaintext or decipher a cipher for confidential communication with each other.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of creating a cryptosystem comprising:
using a secret to produce a first private exponent;
using the first private exponent and two odd prime numbers to produce a modulus, a public exponent, and a second private exponent;
using the secret, the second private exponent, the modulus, and the public exponent in either one of a first application on producing and validating digital signatures or a second application on enciphering and deciphering digital messages.

2. The method of creating a cryptosystem of claim 1, further comprising using a human-entry secret as a part or the whole of the secret.

3. The method of creating a cryptosystem of claim 2, further comprising preventing storing a derivative of the human-entry secret in persistent memory, wherein the derivative is an output of a transformation function that receives the human-entry secret as the single input.

4. The method of creating a cryptosystem of claim 2, wherein the human-entry secret comprises a user selectable password.

5. The method of creating a cryptosystem of claim 1, wherein the secret is selected independently of the two primes, the modulus, and the public exponent.

6. The method of creating a cryptosystem of claim 1, wherein producing the modulus and the public exponent uses no information of the secret.

7. The method of creating a cryptosystem of claim 1, further comprising:
changing the secret and accordingly updating the second private exponent while keeping the modulus and the public exponent unchanged.

8. The method of creating a cryptosystem of claim 7, further comprising:
receiving a new personalized secret and the original secret;
using the new personalized secret to produce a new first private exponent;
using the original secret to produce the original first private exponent;
subtracting the original first private exponent from the new first private exponent to obtain a difference;
subtracting the difference from the second private exponent to obtain a result;
replacing the second private exponent with the result as the updated second private exponent when the result is positive; and
reporting a failure when the result is non-positive.

9. The method of creating a cryptosystem of claim 1, further comprising storing the modulus, the public exponent, and the second private exponent in persistent memory.

10. The method of creating a cryptosystem of claim 1, wherein the modulus and the public exponent are grouped together as a public key and made accessible to processors for validating signatures or enciphering messages.

11. The method of creating a cryptosystem of claim 1, wherein the second private exponent is only made accessible to processors taking part in producing digital signatures or deciphering ciphers.

12. The method of creating a cryptosystem of claim 1, wherein the first private exponent is derived from the secret upon demand for producing a digital signature or deciphering a cipher.

13. A method of creating a cryptosystem based on a split-private-key cryptography comprising:
using a secret to produce a first private exponent;
using the first private exponent and two odd prime numbers to produce a modulus, a public exponent, and a second private exponent; and
changing the secret and accordingly updating the second private exponent while keeping the modulus and the public exponent unchanged.

14. The method of creating a cryptosystem of claim 13, wherein the secret is selected independently of the two odd primes, the modulus, and the public exponent.

15. The method of creating a cryptosystem of claim 13, wherein the secret is used as input to a first function to produce the first private exponent.

16. The method of creating a cryptosystem of claim 15, wherein the first function is a collision-resistant hash function producing a bit string that is encoded as a non-negative integer.

17. The method of creating a cryptosystem of claim 13, further comprising using a public/private key generation process to produce a public key and a private key, wherein the public key is composed of the modulus and the public exponent and the private key is composed of a private exponent and the modulus.

18. The method of creating a cryptosystem of claim 17, wherein the second private exponent is produced using the first private exponent, the two odd prime numbers, and the private exponent as inputs to a second function.

19. The method of creating a cryptosystem of claim 18, wherein the second function uses modular arithmetic and is configured as a function receiving four input variables.

20. The method of creating a cryptosystem of claim 18, wherein the second function is:
f2(y, h, k, z)=c×LCM(h−1, k−1)+z+((−y)mod LCM(h−1, k−1)),
where c is a non-negative integer and LCM stands for least common multiple.

21. The method of creating a cryptosystem of claim 15, wherein the first function is used to derive the first private exponent upon demand for producing a digital signature or deciphering a cipher.

22. The method of creating a cryptosystem of claim 15, wherein the first function is configured by adding a non-negative constant integer to a collision-resistant hash function.

23. The method of creating a cryptosystem of claim 18, wherein the second function is:
f2(y, h, k, z)=c×φ(h×k)+z+((−y)mod φ(h×k)),
where c is a non-negative integer and φ is the Euler φ function.

24. The method of creating a cryptosystem of claim 15, the updating comprising:
receiving a new personalized secret and the original secret;
using the new personalized secret as input to the first function to produce a new first private exponent;
using the original secret as input to the first function to derive the original first private exponent;
subtracting the original first private exponent from the new first private exponent to obtain a difference;
subtracting the difference from the second private exponent to obtain a result; and
replacing the second private exponent with the result as the updated second private exponent when the result is positive;

25. The method of creating a cryptosystem of claim 24, further comprising reporting a failure when the result is non-positive.

26. The method of creating a cryptosystem of claim 24, wherein two processors collaborate to carry out the update.

27. The method of creating a cryptosystem of claim 26, wherein one processor plays a proactive role by accepting the original secret and the new personalized secret to obtain the difference while the other processor plays a reactive role and updates the second private exponent.

28. The method of creating a cryptosystem of claim 24, further comprising validating the original personalized secret before updating.

29. The method of creating a cryptosystem of claim 18, wherein the two primes and the private exponent are destroyed upon producing the second private exponent.

30. The method of creating a cryptosystem of claim 13, wherein the first private exponent is destroyed upon producing the second private exponent.

31. The method of creating a cryptosystem of claim 13, wherein the first private exponent is derived from the secret upon demand for producing a digital signature or deciphering a cipher.

32. The method of creating a cryptosystem of claim 31, wherein the first private exponent is deleted from each memory associated with computations upon termination of producing a digital signature or deciphering a cipher.

33. The method of creating a cryptosystem of claim 13, wherein the secret comprises a plurality of secrets.

34. The method of creating a cryptosystem of claim 13, wherein the secret is a concatenation of a user-chosen password and a device-specific code.

35. A method for producing digital signatures comprising
using a first user secret, a second user secret, a first collision-resistant hash function, a second collision-resistant hash function, and a modulus to produce a digital signature on a digital message;
using the second collision-resistant function, the modulus, and a public exponent to validate a value as a valid digital signature on the digital message; and
updating the first and second user secrets while keeping the modulus and the public exponent unchanged.

36. The method for producing digital signatures of claim 35, wherein producing a digital signature is restricted to a specific device.

37. The method for producing digital signatures of claim 35, wherein producing a digital signature on a digital message M comprises computing:
Hash(M)^{f1(s)}×Hash(M)^{v}(mod n),
where s is the first user secret, v is the second user secret, f1 is the first collision-resistant hash function, Hash is the second collision-resistant hash function, and n is the modulus.

38. The method for producing digital signatures of claim 35, wherein validating a value as a valid digital signature on a digital message M comprises verifying the congruence equality of the expression:
Hash(M)≡SGN^{e}(mod n),
where SGN is the value to be validated, Hash is the second collision-resistant hash function, e is the public exponent, and n is the modulus.

39. The method for producing digital signatures of claim 35, further comprising:
selecting a personalized secret as the first user secret;
using the first user secret as input to the first collision-resistant hash function to produce a first private exponent;
using the first private exponent and two prime numbers to produce the public exponent, the modulus, and a second private exponent; and
considering the second private exponent as the second user secret.

40. A method of producing digital signatures comprising:
using a personalized secret and two odd prime numbers to generate a user crypto-key trio;
receiving an input and retrieving a crypto-key trio;
using the received input and the retrieved crypto-key trio in computing a digital signature; and
validating the digital signature when the received input matches the personalized secret and the retrieved crypto-key trio matches the user crypto-key trio.

41. The method of producing digital signatures of claim 40, comprising:
using the personalized secret as input to a first transformation function to produce a first private exponent;
using the two odd primes to produce a modulus, a public exponent, and a private exponent;
using the first private exponent, the two primes, and the private exponent as four inputs to a second transformation function to produce a second private exponent; and
grouping the second private exponent, the public exponent, and the modulus as the user crypto-key trio.

42. The method of producing digital signatures of claim 40, wherein the personalized secret comprises a user-selectable password.

43. The method of producing digital signatures of claim 40, further comprising including either a human-entry secret, an automatically readable secret, or both in the personalized secret.

44. The method of producing digital signatures of claim 43 further comprising preventing storing a derivative of the human-entry secret in persistent memory, wherein the derivative is an output of a transformation function receiving the human-entry secret as the only input.

45. A method of producing digital signatures comprising using a reactive processor to assist a proactive processor in producing digital signatures,
wherein the proactive processor leads the task of producing a digital signature while the reactive processor producing a reactive partial digital signature with a crypto-key trio and sending the reactive partial digital signature to the proactive processor in response to a request for assistance.

46. The method of producing digital signatures of claim 45, wherein producing a digital signature on the proactive processor comprises:
receiving a digital message and a personalized secret input;
computing a hash value on the digital message;
sending the hash value to the reactive processor as a request for assistance;
receiving the reactive partial digital signature along with a public key consisting of a public exponent and a modulus from the reactive processor,
computing a proactive partial digital signature on the digital message using the hash value, personalized secret input, and modulus;
using the modulus in modulo multiplication to multiply the reactive and proactive partial digital signatures to produce the digital signature;
using the public key to determine whether the digital signature is valid; and
invalidating the digital signature when the personalized secret input mismatch a personalized secret, wherein the personalized secret is one input in a key generation process to produce the crypto-key trio.

47. The method of claim 46, further comprising changing the personalized secret to a new secret and updating the crypto-key trio accordingly but keeping the two public-key components of the trio unchanged.

48. A method of generating a symmetric crypto key used by a private key holder and a second party comprising:
creating and encrypting a session key by the second party;
sending the encrypted session key to the private key holder;
receiving a personalized secret input by the private key holder;
retrieving a crypto-key trio consisting of a second private exponent, a modulus, and a public exponent by the private key holder;
validating the personalized secret input and the retrieved crypto-key trio by the private key holder;
producing a first private exponent using the personalized secret by the private key holder; and
using the first and second private exponents as two decryption subkeys to decipher the encrypted session key to obtain the session key by the private key holder.

49. The method of generating a symmetric crypto key of claim 48, further comprising validating the personalized secret input and the retrieved crypto-key trio via validating a digital signature produced with the personalized secret input and the retrieved crypto-key trio.

50. A cryptosystem comprising:
means for using a personalized secret and two odd primes to produce a second private exponent, a public private exponent, and a modulus as a crypto-key trio;
means for using the personalized secret and the crypto-key trio to produce and validate a digital signature;
means for changing the secret to a new secret and updating the second private exponent while keeping the public exponent and the modulus unchanged.

51. The cryptosystem of claim 50 further comprising means for creating a symmetric crypto key for confidential communications between a private-key holder and a second party.
